(19) United States
(12) Patent Application Publication
(10) Pub. No.: US 2011/0127863 A1
(43) Pub. Date: Jun. 2, 2011

(54) ALTERNATOR WITH SYNCHRONOUS RECTIFICATION EQUIPPED WITH AN IMPROVED ELECTRONIC POWER MODULE

(76) Inventors: Marc Tunzini, Versailles (FR); Fabrice Tauvron, Athis-Mons (FR); Olivier Grammont, Hardelot-Plage (FR); Olivier Danger, Longvilliers (FR); Blaise Rouleau, Clamart (FR); Régis Seidenbinder, Choisy Le Roi (FR); Victor Dos Santos, Antony (FR)

(21) Appl. No.: 12/828,627

(22) Filed: Jul. 1, 2010

(30) Foreign Application Priority Data
Jul. 3, 2009 (FR) FR 09/54602

(51) Int. Cl. H02K 11/04

(52) U.S. Cl. 310/71; 310/68 D

(57) ABSTRACT

An alternator includes a stator (S), a rotor (R) and a transistor bridge, which form a synchronous rectification. The synchronous rectification is in the form of an over-moulded mecatronic housing (2). The mecatronic housing includes power connection terminals (23, 24), and contains a plurality of electronic power substrates (3₀, 3₁, 3₂) which have the same architecture, and in each of which there is implanted at least a first electronic chip (300A, 300B) of the transistor bridge. According to one embodiment, the electronic power substrate is of the IMS, DBC or PCB type.

This application is a US Utility Patent Application, and claims priority to French Patent Application Number 09/54602 filed Jul. 3, 2009.

### FIELD OF THE INVENTION

The present invention relates in general to the field of rotary electrical machines, in particular for a motor vehicle. More particularly, the invention relates to an alternator with synchronous rectification which is equipped with an improved electronic power module.

### BACKGROUND OF THE INVENTION

A rotary electrical machine of the alternator-starter type comprising electronic power means is known from FR-2886477B1. These electronic power means include a power transistor bridge of the MOSFET type, and provide a reversible analogue-digital (AC/DC) power converter function.

In the mode in which the rotary electrical machine is functioning as an alternator, the converter provides rectification of alternating phase voltages produced by the alternator into a direct supply voltage (typically 14 Volts) which supplies an on-board supply network of the vehicle. In the mode in which the rotary electrical machine is functioning as a motor/starter, the converter provides phase voltages which supply stator windings of the rotary electrical machine. Rotation of the rotor of the rotary electrical machine with sufficient mechanical torque is thus created, so as to assure the starting of the thermal engine of the vehicle. The phase voltages which are supplied are obtained by chopping, by means of the power transistor bridge, of the on-board supply network direct voltage (direct voltage supplied by an energy storage battery).

The electronic power means according to FR-2886477B1 comprises three identical bridge branch modules and a control module which incorporates a circuit of the ASIC type. The bridge branch modules each form a branch of the transistor bridge.

The architecture of the bridge branch module according to FR-2886477B1 is represented in FIG. 4C of this patent. MOSFET transistors, in the form of bare electronic chips, are soldered onto connection gates known as leadframes, which are over-moulded in a mecatronic housing. These leadframes are kept in position on a metal bearing plate by means of an electrically insulating plate which is sandwiched between the leadframes and the bearing plate. The insulating plate has properties of good thermal conduction, so as to transmit the calories which are generated by the electronic chips to a heat dissipater placed below the metal bearing plate of the module.

The technology disclosed by FR-2886477B1 has various applications in rotary electrical machines, and in particular gives very good results in terms of quality and performance, in its application to an alternator-starter.

In the context of reduction of emissions of CO₂ and the development of high-performance alternators, it is desirable to provide new technology which makes possible greater integration and reduction of costs.

### SUMMARY OF THE INVENTION

The present invention relates to an alternator with synchronous rectification for a motor vehicle comprising a stator, a rotor and a transistor bridge, which form synchronous rectification means.

According to the invention, the synchronous rectification means are in the form of an over-moulded mecatronic housing, and the mecatronic housing comprises power connection terminals, and contains a plurality of electronic power substrates which have the same architecture, and in each of which there is implanted at least a first electronic chip of the transistor bridge.

Preferably, an electronic power substrate is of the IMS, DBC or PCB type.

According to a particular characteristic, at least one of the power connection terminals is connected electrically to an electronic chip by means of at least a first soldered connection wire.

According to another particular characteristic, an electronic power substrate also comprises at least a first intermediate connection track, onto which there are soldered a second end of the first connection wire, the first end of the first connection wire being soldered onto the power connection terminal, as well as a first end of a second connection wire, the second end of the second connection wire being soldered onto the first electronic chip.

According to another particular characteristic, an electronic power substrate also comprises at least a second intermediate connection track, onto which there are soldered a first end of a third connection wire, the second end of the third connection wire being soldered onto a second electronic chip which is implanted on the electronic power substrate, as well as a first end of a fourth connection wire, the second end of the fourth connection wire being soldered onto a first power track of the mecatronic housing.

According to yet another particular characteristic, the electronic power substrate comprises at least a third track, onto which there are soldered an electronic chip and a first end of a fifth connection wire, the second end of the fifth connection wire being soldered onto a second power track of the mecatronic housing.

According to yet another characteristic, the first and second power tracks of the mecatronic housing are connected respectively to direct voltage power connection terminals.

According to a particular characteristic of this embodiment, each of the electronic power substrates comprises a transistor bridge branch formed by at least the first and second electronic chips.

Preferably, the mecatronic housing also contains a control circuit substrate which is connected electrically to each of the electronic power substrates via a connection bus comprising a plurality of bus tracks in each of the electronic power substrates, and a plurality of connection wires which are soldered between the said plurality of bus tracks.

The invention provides the following advantages:
The structure of an electronic power module with a plurality of electronic power modules with the same architecture makes it possible to obtain an increase in the volumes on the electronic power substrates, and thus to reduce the costs.
The electronic power substrates are pre-equipped, and the soldering on the chips is carried out before the implantation of the substrates in the mecatronic housing, thus permitting detection of the faults and scrapping at an early stage of manufacture.
The electrical connection of the electronic power substrates to the mecatronic housing by means of connection wires permits good mechanical isolation between the power connection terminals and the inner structure of the mecatronic housing. The inner structure of the housing is protected against mechanical stresses on the power connection terminals, thus preventing any perforations at the level of the electrical insulators, or deterioration of the welds and soldering.
The use of wires for connection with the terminals of the mecatronic housing facilitates manufacture in two stages, thus limiting scrap. Once the substrate has been equipped, it is controlled. The integration in the mecatronic housing no longer comprises any delicate soldering on the chip, and the number of mecatronic housings which are scrapped decreases substantially.
The power connection wires can be produced in a strip.
The tracks onto which the ends of the connection wires are soldered do not require a precise location, since the use of connection wires permits self-adaptation and variability of the location of the tracks.
The cross-section of the dimensions of the connection wires can be such as to act as a fuse in the event of a short-circuit. The rotary electrical machine is thus protected upstream against any additional deteriorations.
The thermal insulation obtained between the stator (the temperature of which may reach 250° C.) of the rotary electrical machine and the electronic chips is improved by means of connection wires, in comparison with the technology which uses a leadframe. Maintenance of a reduced junction temperature is assisted by limiting the heat which rises from the stator windings to the silicon of the electronic chips.
Since the number of welds provided in the mecatronic housing is limited, taking into consideration the fact that the substrates are pre-equipped, it is possible to use a lower-class plastic over-moulding material for the mecatronic housing.

### BRIEF DESCRIPTION OF THE DRAWINGS

Other aspects, objectives and advantages of the present invention will become more apparent from reading the following detailed description of a particular embodiment of it, provided by way of non-limiting example with reference to the attached drawings, in which:

FIG. 1 is a plan view of an electronic power module contained in a rotary electrical machine according to the invention;

FIG. 2 is a view in cross-section according to an axis AA of FIG. 1;

FIG. 3 is a view in cross-section according to an axis BB of FIG. 1;

FIG. 4 is an enlargement of a portion F of FIG. 3;

FIG. 5 represents the wiring diagram of the electronic power module in FIG. 1; and

FIG. 6 shows the rear part in cross-section of a rotary electrical machine according to the invention, in the form of an alternator with synchronous rectification.

### DETAILED DESCRIPTION

As shown in FIG. 5, the rotary electrical machine according to the invention comprises in a conventional manner a stator S and a rotor R and an electronic power module 1 according to the invention. A description will be provided firstly of the general architecture of an electronic power module 1, in a particular embodiment of the invention which concerns a three-phase alternator with synchronous rectification.

The wiring diagram of the module 1 in this particular embodiment of the invention is shown in FIG. 5.

As shown in FIG. 5, the module 1 comprises a transistor bridge 3₀, 3₁, 3₂ and a control circuit 4.

The transistor bridge comprises six power transistors of the MOSFET type distributed in three bridge branches 3₀, 3₁, 3₂. On their gate electrode, the MOSFET transistors each receive a respective control signal which is supplied by the circuit 4, and controls functioning of the transistors with synchronous rectification. A mid-point of each of the bridge branches 3₀, 3₁, 3₂ is connected to a corresponding stator winding 23₀, 23₁, 23₂ of the rotary electrical machine.

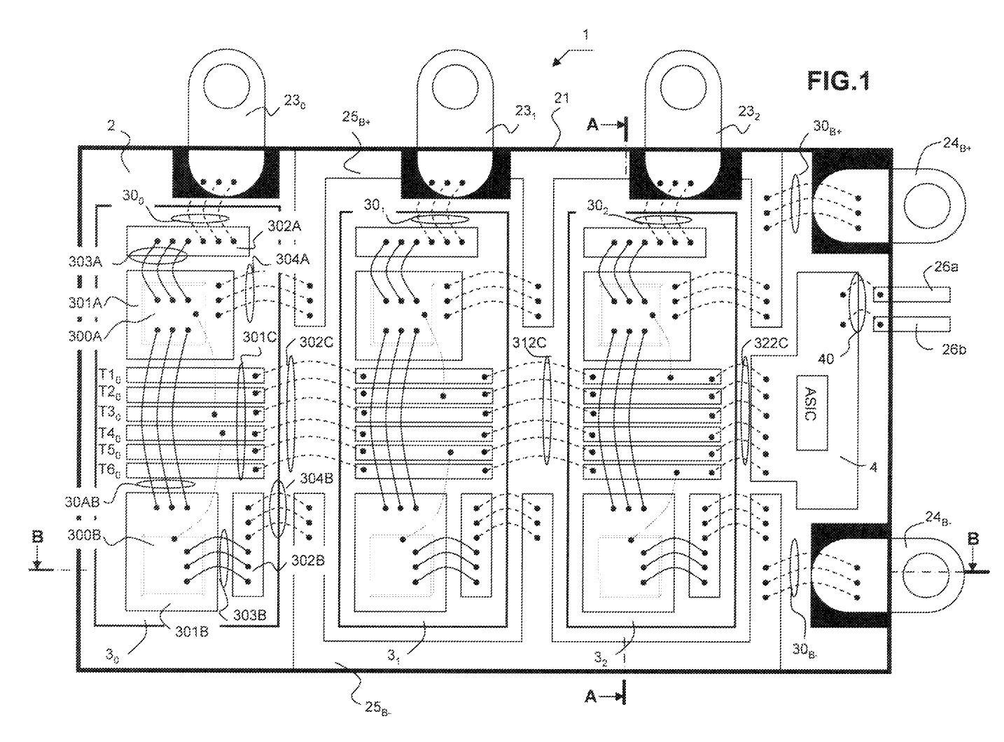

With reference to FIG. 1, the electronic power module 1 is produced in the form of an over-moulded mecatronic housing.

In this particular embodiment, the electronic module 1 comprises substantially a housing 2, three substrates 3₀, 3₁, 3₂ equipped with bridge branches which correspond respectively to the three phases of the machine, and a control circuit substrate 4.

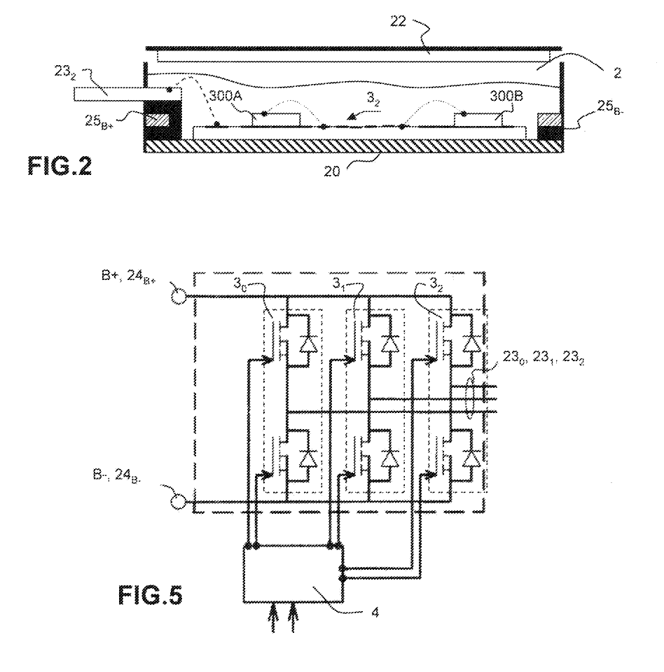

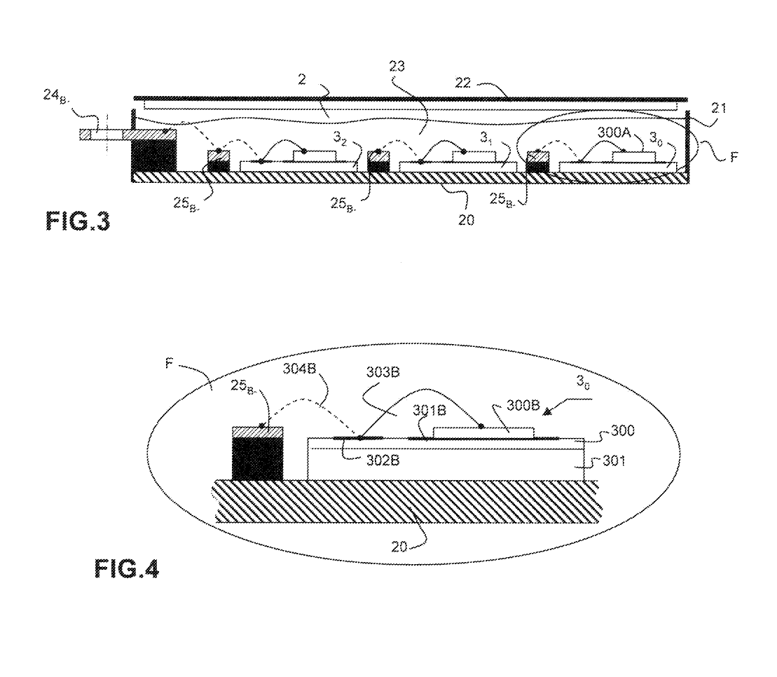

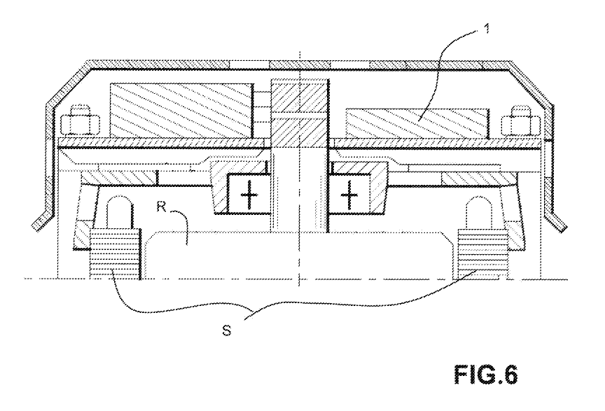

The housing 2 substantially comprises a metal bearing plate 20, which for example is made of aluminium, and lateral walls 21 which are over-moulded on the periphery of the bearing plate 20 such as to form a housing structure. A cover 22 made of plastic material, which can be seen in FIGS. 2 and 3, is also provided such as to close the housing 1 during a final production step of the latter. The cover 22 is sealed on the ends of the walls 21 by being soldered or glued. Before the cover 22 is sealed, a filling gel 23 which can be seen in FIGS. 2 and 3 is poured into the housing 2, such as to cover the different sub-assemblies, thus assuring better mechanical retention and better protection.

The plastic which is used in the housing 2, both for the over-moulded parts and for the cover 22, can be selected in any quality standard which will withstand a maximum temperature of approximately 200° C.

The bearing plate 20, which is known as a bearing plate, is designed to be placed against a corresponding surface of a heat dissipater or radiator, and must therefore have very good thermal conduction.

Preferably, the bearing plate 20 will be covered with anti-corrosion protection, so as to prevent surface oxidation which can modify its heat-conduction characteristics.

The housing 2 is provided with power conduction tracks 25_{B+} and 25_{B-}, with phase connection terminals 23₀, 23₁ and 23₂, and with direct voltage connection terminals 24_{B+} and 24_{B-}.

In this embodiment, as shown in FIG. 1, the power tracks 25_{B+} and 25_{B-} are in the form of an “E”, and are disposed symmetrically opposite, on both sides of a longitudinal axis (not shown) of the housing 2.

The power tracks 25_{B+} and 25_{B-} participate in the interconnection of the substrates 3₀, 3₁ and 3₂, to the direct voltage connection terminals 24_{B+} and 24_{B-}, respectively.

The power tracks 25_{B+} and 25_{B-} are kept mechanically and electrically insulated by means of the over-moulding plastic.

The parts which are represented in black in the figures correspond to the over-moulding plastic.

Over-moulding plastic portions which are interposed between the tracks 25_{B+} and 25_{B-} and the bearing plate 20, and are shown in FIG. 3 for the track 25_{B-}, isolate the tracks 25_{B+}, 25_{B-} electrically from the bearing plate 20 and render them mechanically integral with the latter. As shown in FIGS. 1 and 2, the track 25_{B+} is embedded in the over-moulding plastic at the level of the phase connection terminals 23₁ and 23₂, such as to guarantee electrical insulation of the track 25_{B+} relative to the said terminals.

The phase connection terminals 23₀, 23₁ and 23₂ permit electrical connection of the conductive wires at the end of the stator coils to the substrates 3₀, 3₁ and 3₂ respectively. As shown in FIG. 2 for the terminal 23₂ only, the terminals 23₀, 23₁ and 23₂ pass through the lateral wall 21 obtained by over-moulding, and are retained mechanically by the over-moulded plastic portions interposed between them and the bearing plate 20.

The direct voltage connection terminals 24_{B+} and 24_{B-} permit connection of the tracks 25_{B+} and 25_{B-} to the direct voltage terminals B+ and B− of the rotary electrical machine, respectively. In the same manner as for the terminals 23₀, 23₁ and 23₂, the terminals 24_{B+} and 24_{B-} pass through the lateral wall 21 obtained by over-moulding, and are retained mechanically by the plastic over-moulding portions interposed between them and the bearing plate 20.

According to the invention, the connection terminals 23₀, 23₁ and 23₂ and 24_{B+} and 24_{B-} of the housing 2 are connected electrically to corresponding elements of the electronic module 1 by means of soldered bonding wires.

As shown in FIG. 1, in this embodiment, the terminals 23₀, 23₁ and 23₂ are connected electrically to the substrates 3₀, 3₁ and 3₂ by means of three groups of bonding wires 30₀, 30₁ and 30₂, respectively. Each of the groups of bonding wires 30₀, 30₁ and 30₂ comprises three wires. The terminals 24_{B+} and 24_{B-} are connected to the tracks 25_{B+} and 25_{B-} by means of groups of bonding wires 30_{B+} and 30_{B-}, respectively. The groups of bonding wires 30_{B+} and 30_{B-} also each comprise three wires in this embodiment.

In general, the number of wires used for a connection and their diameter are determined on the basis of the intensity of the current which the connection must withstand, and the robustness required for the connection concerned.

As shown in FIG. 1, control terminals 26A and 26B also equip the housing 2. These terminals 26a, 26b which pass through the wall 21 are retained mechanically, in the same way as the other terminals, by the over-moulding plastic. A group of bonding wires 40, comprising two wires in this embodiment, connects the terminals 26a, 26b electrically to the substrate 4 of the control circuit.

The bridge arm substrates 3₀, 3₁ and 3₂ will now be described in detail.

The bridge arm substrates 3₀, 3₁ and 3₂ are electronic power substrates which in general can be derived from different technologies. Technologies of the type IMS, DBC or PCB (Insulated Metal Substrate, Direct Bonded Copper and Printed Circuit Board) can be used, depending on the applications.

According to one characteristic of the invention, the bridge arm substrates 3₀, 3₁ and 3₂ are standard elements, and all three have the same architecture. The differences which exist between the three substrates lie substantially in the electrical interconnection. The substrate 3₀ is described in detail hereinafter.

In this particular embodiment, the electronic power substrates are produced using IMS technology.

This technology is a good compromise for applications which dissipate energy, which is the case in this embodiment in which the electronic chips are power transistors of the MOSFET type which function as synchronous rectifiers.

As can be seen more particularly in FIGS. 1 to 4, the substrate 3₀ comprises substantially two electronic chips 300A and 300B, a printed circuit 300, and a metal bearing plate 301.

The printed circuit 300 is a simple face printed circuit on a thin layer of epoxy resin of type FR4. The printed circuit 300 is placed and glued onto the metal bearing plate 301, which in this embodiment is made of aluminium. It will be appreciated that other materials which are good conductors of heat can be used for this metal bearing plate 301.

When the bridge arm substrate 3₀ is fitted in the housing 2, the metal bearing plate 301 of the latter is placed against the metal bearing plate 20 of the housing 2, thus assuring good thermal contact for discharge of the heat released by the electronic chips 300A and 300B.

Metallised connection tracks and dots 301A, 301B, 302A, 302B and 301C are provided on the printed circuit 300.

The electronic chips 300A, 300B are glued or soldered respectively onto the connection tracks 301A, 301B.

The tracks 302A, 302B are intermediate connection tracks for connection of the chips 300A, 300B of the substrate 3₀ to the housing 2, respectively.

According to the invention, the intermediate connection tracks 302A and 302B permit electrical connection of the substrate 3₀ to the housing 2, without needing to carry out soldering on the chips. At this stage of production of the electronic module 1, a fault detected upon completion of implantation of the substrates 3₀, 3₁ and 3₂ in the housing 2 would mean that the electronic module assembly 1 would have to be scrapped. Since soldering onto a chip is a delicate operation, the series of operations of soldering onto the chips of the substrate are carried out at the stage of production of the substrate, such that, if a fault is detected at the end of production of the substrate, it is only the faulty substrate which is scrapped, and not the electronic module assembly.

The track 302A is used for the electrical connection of the chip 300A to the terminal 23₀ of the housing 2. This connection is obtained by means of the two groups of connection wires 30₀ and 303A.

The group of connection wires 30₀ is used to connect the terminal 23₀ to the intermediate connection track 302A, and the group of connection wires 303A is used to connect the chip 300A to the intermediate connection track 302A.

A connection of this type with two groups of wires 30₀ and 303A makes it possible to use different wires for the two groups. Thus, it is possible to have connection wires with a larger cross-section for the group 30₀ compared with the group 303A, so as to make the connection between the terminal 23₀ and the substrate 3₀ more robust.

The track 302B is used for connection of the chip 300B to the conductive power track 25_{B-} of the housing 2. In the same way as the track 302A, the track 302B allows the substrate 3₀ to be connected to the housing 2 without having to carry out soldering directly on the chip 300B. The connection between the chip 300B and the track 302B by the group of connection wires 303B is carried out at the stage of production of the substrate. The connection between the track 302B and the conductive power track 25_{B-} by the group of connection wires 304B is carried out at the stage of implantation of the substrate 3₀ in the housing 2.

As shown in FIG. 1, a group of three connection wires 30AB connects the chips 300A and 300B. In addition, two groups of additional connection wires 304A and 302C are used to finish the connection of the substrate 3₀ in the housing 2.

The group of connection wires 304A comprises three wires in this embodiment, and interconnects the connection track 301A to the conductive power track 25_{B+}.

The group of connection wires 302C comprises six wires in this embodiment, and interconnects six tracks T1₀ to T6₀ for control signals of the substrate 3₀ to six tracks T1₁ to T6₁ for corresponding control signals of the substrate 3₁.

The substrates 3₁ and 3₂ are connected to the terminals 23₁ and 23₂ respectively, and to the conductive power tracks 25_{B+} and 25_{B-}, in the same manner as the substrate 3_{0.} The six tracks T1₁ to T6₁ for control signals of the substrate 3₁ are interconnected to six tracks T1₂ to T6₂ for corresponding control signals of the substrate 3₂ by a group of six connection wires 312C similar to the group 302C. The control signals bus formed by the connection of the tracks T1₀ to T6₀, T1₁ to T6₁ and T1₂ to T6₂ is connected to the control circuit 4 by a group of six connection wires 322C.

In this embodiment, the control circuit 4 is produced by means of an ASIC chip fitted onto a substrate. It will be appreciated that other techniques can be used, for example fitting of the ASIC chip onto ceramic.

As shown in FIG. 1, the bridge arm substrates 3₀, 3₁ and 3₂ are individualised by their interconnection to the control signal bus formed by the interconnected tracks T1₀ to T6₀, T1₁ to T6₁ and T1₂ to T6₂. The chips of the substrate 3₀ are each connected by a connection wire to the tracks T3₀ and T4₀ of the substrate 3₀ respectively. The chips of the substrate 3₁ are each connected by a connection wire to the tracks T2₁ and T5₁ of the substrate 3₁ respectively. The chips of the substrate 3₂ are each connected by a connection wire to the tracks T1₂ and T6₂ of the substrate 3₂ respectively. These connections of the chips 3₀, 3₁ and 3₂ to the control signal bus are preferably produced during the manufacture of the substrates, for the reasons previously indicated, because of the soldering on the chips.

It will be appreciated that the invention is not limited to the above-described particular embodiment. Other embodiments are possible according to the applications envisaged by persons skilled in the art, and remain within the scope of the appended claims.

1. An alternator with synchronous rectification for a motor vehicle comprising a stator (S), a rotor (R) and a transistor bridge, which form synchronous rectification means, characterised in that the synchronous rectification means is in the form of an over-moulded mecatronic housing (2), and the mecatronic housing comprises power connection terminals (23, 24), and contains a plurality of electronic power substrates (3₀, 3₁, 3₂) which have the same architecture, and in each of which there is implanted at least a first electronic chip (300A, 300B) of the transistor bridge.

2. An alternator with synchronous rectification according to claim 1, characterised in that the electronic power substrate (3) is of the IMS, DBC or PCB type.

3. An alternator with synchronous rectification according to claim 1, characterised in that at least one of the power connection terminals is connected electrically to an electronic chip by means of at least a first soldered connection wire (30, 303A, 303B, 304A, 304B).

4. An alternator with synchronous rectification according to claim 3, characterised in that an electronic power substrate (3₀) also comprises at least a first intermediate connection track (302A), onto which there are soldered a second end of the first connection wire (30₀), the first end of the first connection wire (30₀) being soldered onto the power connection terminal (23₀), as well as a first end of a second connection wire (303A), the second end of the second connection wire (303A) being soldered onto the first electronic chip (300A).

5. An alternator with synchronous rectification according to claim 4, characterised in that an electronic power substrate (3₀) also comprises at least a second intermediate connection track (302B), onto which there are soldered a first end of a third connection wire, the second end of the third connection wire (303B) being soldered onto a second electronic chip (300B) which is implanted on the electronic power substrate (3₀), as well as a first end of a fourth connection wire, the second end of the fourth connection wire being soldered onto a first power track (25_{B-}) of the mecatronic housing (2).

6. An alternator with synchronous rectification according to claim 5, characterised in that the electronic power substrate (3₀) comprises at least a third track (301A), onto which there are soldered an electronic chip (300A) and a first end of a fifth connection wire (304A), the second end of the fifth connection wire (304A) being soldered onto a second power track (25_{B+}) of the mecatronic housing (2).

7. An alternator with synchronous rectification according to claim 6, characterised in that the first and second power tracks (25_{B+}, 25_{B-}) of the mecatronic housing (2) are connected respectively to direct voltage power connection terminals (24_{B+}, 24_{B-}).

8. An alternator with synchronous rectification according to claim 7, characterised in that each of the electronic power substrates (3₀, 3₁, 3₂) comprises a transistor bridge branch formed by at least the first and second electronic chips (300A, 300B).

9. An alternator with synchronous rectification according to claim 1, characterised in that the mecatronic housing (2) also contains a control circuit substrate (4) which is connected electrically to each of the electronic power substrates (3₀, 3₁, 3₂) via a connection bus (301C, 302C, 312C, 322C) comprising a plurality of bus tracks (T1 to T6) in each of the electronic power substrates (3₀, 3₁, 3₂), and a plurality of connection wires (302C, 312C, 322C) which are soldered between the plurality of bus tracks.
